(19) United States
(12) Patent Application Publication
(10) Pub. No.: US 2015/0241968 A1
(43) Pub. Date: Aug. 27, 2015

(54) Method for Processing Information and Electronic Device

(71) Applicant: Lenovo (Beijing) Co., Ltd., Beijing (CN)

(72) Inventor: Jesper Brehmer, Beijing (CN)

(21) Appl. No.: 14/470,084

(22) Filed: Aug. 27, 2014

(30) Foreign Application Priority Data
Feb. 24, 2014 (CN) 201410062588.3

(51) Int. Cl. G06F 3/01; G06F 3/03; G06F 3/0487; G06F 3/0484

(52) U.S. Cl. CPC G06F 3/014; G06F 3/04845; G06F 3/0317; G06F 3/0487; G06F 2203/04806

(57) ABSTRACT

An electronic device includes a housing, a first display component and a second display component each fixed on the housing, and M sensors. The housing includes a fixing structure through which the electronic device is fixable to a first operation body for a user. The first display component includes a display exposed on a first surface of the housing. The second display component includes a projection lens exposed on a second surface of the housing. The first surface and the second surface intersect with each other. The M sensors are fixed through the housing. A method for processing information includes: acquiring triggering information through a first sensor if the electronic device is fixed to the first operation body; and projecting, in response to the triggering information, a graphical interaction interface onto an operation portion of the first operation body.

### CROSS REFERENCES OF RELATED APPLICATION

The present application claims the priority to Chinese Patent Application No. 201410062588.3, entitled “METHOD FOR PROCESSING INFORMATION AND ELECTRONIC DEVICE”, filed on Feb. 24, 2014 with the State Intellectual Property Office of People's Republic of China, which is incorporated herein by reference in its entirety.

### FIELD

The present disclosure relates to data processing technologies, and in particular, to a method for processing information and an electronic device.

### BACKGROUND

Conventionally, some electronic devices such as smart watches are usually worn around wrists of users. Graphical interaction interfaces of the smart watches are displayed on displays of the smart watches. The users may perform information interactions with the smart watches only through the graphical interaction interfaces displayed on the displays, thereby causing a poor user experience.

### SUMMARY

In view of this, a method for processing information and an electronic device are provided in the disclosure, to solve a problem in conventional technologies that users may perform information interactions with smart watches only through graphical interaction interfaces displayed on displays and thereby causing a poor user experience.

A method for processing information is provided. The method is applied to an electronic device. The electronic device includes a housing, a first display component, a second display component and M sensors. The housing includes a fixing structure through which the electronic device is fixable to a first operation body of a user. The first display component and the second display component are fixed on the housing. The first display component includes a display, and the display is exposed on a first surface of the housing. The second display component includes a projection lens, and the projection lens is exposed on a second surface of the housing. The first surface and the second surface intersect with each other. The M sensors are fixed through the housing.

The method includes:
acquiring triggering information through a first sensor among the M sensors in the case that the electronic device is fixed to the first operation body of the user through the fixing structure; and
projecting, in response to the triggering information, a graphical interaction interface onto an operation portion of the first operation body, where the operation portion and the second surface of the housing of the electronic device are located on a same side in the case that the electronic device is fixed to the first operation body of the userthrough the fixing structure.

An electronic device is provided. The electronic device includes a housing, a first display component, a second display component and M sensors. The housing includes a fixing structure through which the electronic device is fixable to a first operation body of a user. The first display component and the second display component are fixed on the housing. The first display component includes a display, and the display is exposed on a first surface of the housing. The second display component includes a projection lens, and the projection lens is exposed on a second surface of the housing. The first surface and the second surface intersect with each other. The M sensors are fixed through the housing.

The electronic device further includes a first acquisition unit and a first response unit.

The first acquisition unit is for acquiring triggering information through a first sensor among the M sensors in the case that the electronic device is fixed to the first operation body of the user through the fixing structure.

The first response unit is for projecting, in response to the triggering information, a graphical interaction interface onto an operation portion of the first operation body through the projection lens. The operation portion and the second surface of the housing of the electronic device are located on a same side in the case that the electronic device is fixed to the first operation body of the user through the fixing structure.

### BRIEF DESCRIPTION OF THE DRAWINGS

Drawings to be used in descriptions of embodiments or conventional technologies are described briefly hereinafter to clarify technical solutions according to the embodiments of the disclosure or the conventional technologies. Obviously, the drawings in the following description are only according to some embodiments of the disclosure. Other drawings may be obtained by those skilled in the art based on the drawings without any creative works.

FIG. 1 is a schematic flowchart of a method for processing information according to an embodiment of the disclosure;

FIG. 2a and FIG. 2b are schematic structural diagrams of an electronic device according to an embodiment of the disclosure;

FIG. 3 illustrates that an electronic device fixed to a first arm projects a graphical interaction interface onto a first hand on a first arm through a projection lens;

FIG. 4 is another schematic flowchart of a method for processing information according to an embodiment of the disclosure;

FIG. 5 is a schematic diagram of an interactive operation in a method for processing information according to an embodiment of the disclosure;

FIG. 6 is a schematic diagram of an interactive operation in a method for processing information according to an embodiment of the disclosure;

FIG. 7 is a schematic diagram of an interactive operation in a method for processing information according to an embodiment of the disclosure;

FIG. 8 is a schematic diagram of an interactive operation in a method for processing information according to an embodiment of the disclosure;

FIG. 9 is a schematic diagram of an interactive operation in a method for processing information according to an embodiment of the disclosure;

FIG. 10 is a schematic diagram of an interactive operation in a method for processing information according to an embodiment of the disclosure;

FIG. 11 is a schematic structural diagram of an electronic device according to an embodiment of the disclosure; and

FIG. 12 is another schematic structural diagram of an electronic device according to an embodiment of the disclosure.

### DETAILED DESCRIPTION OF THE EMBODIMENTS

Technical solutions according to embodiments of the disclosure are hereinafter described clearly and completely in conjunction with drawings in the embodiments of the disclosure. Obviously, the described embodiments are only a part of rather than all of the embodiments of the disclosure. All other embodiments obtained by those skilled in the art based on the embodiments of the disclosure without creative efforts should fall within the scope of protection of the disclosure.

With the method for processing information and the electronic device provided in the disclosure, the triggering information may be acquired by the sensor in the case that the electronic device is fixed to the first operation body of the user through the fixing structure. The graphical interaction interface is projected onto the operation portion of the first operation body through the projection lens. In the method for processing information and the electronic device provided in the disclosure, the graphical interaction interface may be projected onto an anterior part of the first hand of the user through the projection lens. Therefore, the user may perform information interaction with the electronic device through the graphical interaction interface displayed on the anterior part of the first hand, and a better user experience is achieved.

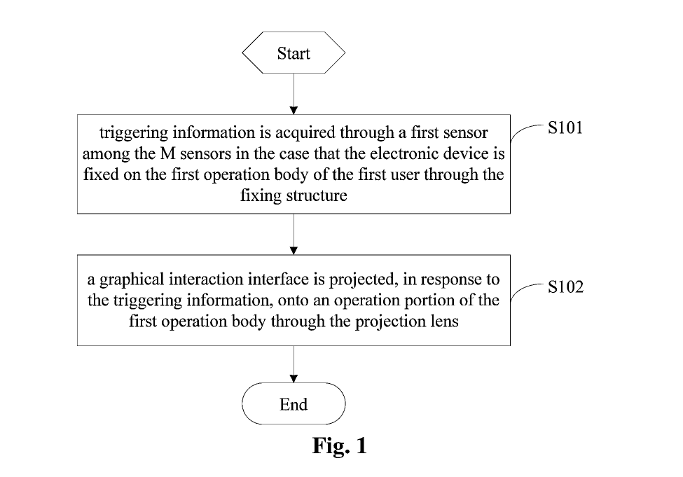

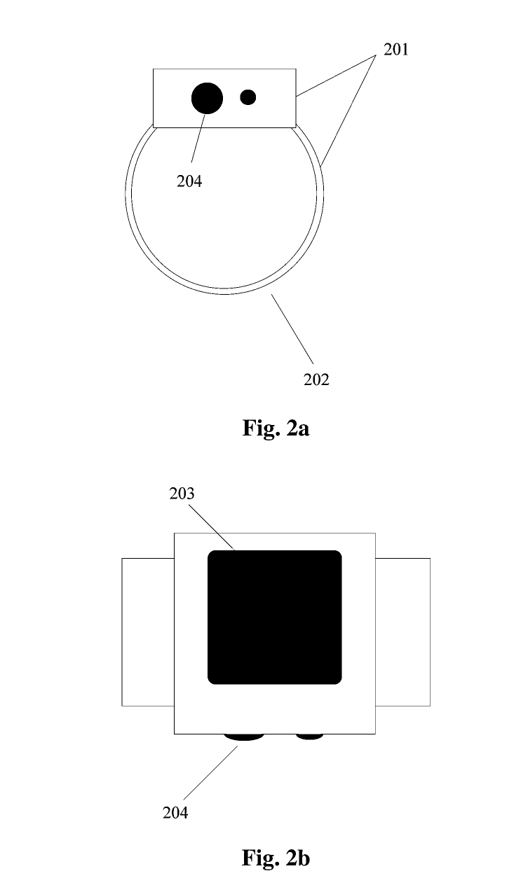

FIG. 1 is a schematic flowchart of a method for processing information according to an embodiment of the disclosure. The method is applied to an electronic device. FIG. 2 is a schematic structural diagram of the electronic device. The electronic device may include a frame structure or housing 201, a first display component, a second display component and M sensors. The housing 201 includes a fixing structure 202. The fixing structure 202 may fix the electronic device on a first operation body of a user. The first display component and the second display component are fixed on the housing 201. The first display component includes a display 203. The display 203 is exposed on a first surface of the housing 201. The second display component includes a projection lens 204. The projection lens is exposed on a second surface of the housing 201. The first surface and second surface of the housing intersect with each other. The M sensors are fixed through the housing 201. The method may include the following steps S101-S102.

In the step S101, triggering information is acquired through a first sensor among the M sensors in the case that the electronic device is fixed to the first operation body of the user through the fixing structure.

The first operation body is a first arm of the user and a first hand on the first arm.

According to the embodiment, there are many implementations for the electronic device to acquire the triggering information through the first sensor among the M sensors.

In one implementation, the first sensor may be a touch screen, and a touch button is displayed on the touch screen. The electronic device acquires the triggering information in the case that the touch screen detects that the touch button is touched.

In another implementation, the first sensor may be a physical button provided on the housing. The electronic device acquires the triggering information in the case that the physical button is pressed.

In still another implementation, the first sensor may be a camera. The camera may capture a gesture of the user. The electronic device may acquire the triggering information in the case that the gesture captured by the camera matches a set gesture.

In the step S102, a graphical interaction interface is projected, in response to the triggering information, onto an operation portion of the first operation body through the projection lens.

The operation portion and the second surface of the housing of the electronic device are located on a same side in the case that the electronic device is fixed to the first operation body of the user through the fixing structure.

The operation portion of the first operation body is the first hand on the first arm.

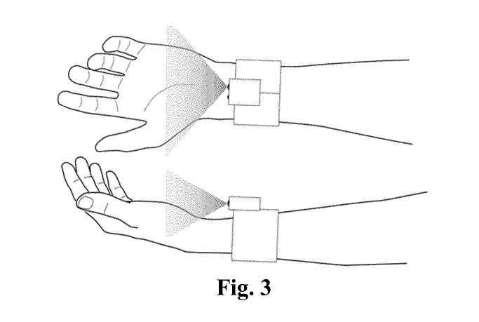

To project the graphical interaction interface onto the operation portion of the first operation body through the projection lens is to project the graphical interaction interface onto a hand of the user through the projection lens. FIG. 3 illustrates that the electronic device fixed to the first arm projects the graphical interaction interface onto the first hand on the first arm through the projection lens.

In one case, a surface of the operation portion of the first operation body, functioning as a projection screen for displaying the graphical interaction interface, may be approximately parallel to the second surface of the housing of the electronic device. That is, an anterior part of the first hand on the first arm is approximately perpendicular to the first arm. In this case, the electronic device may project the graphical interaction interface onto the anterior part of the first hand through the projection lens.

It should be understood that the user may feel tired if he keeps the anterior part of the first hand perpendicular to the first arm for a long time. In another case, the surface of the operation portion of the first operation body, functioning as the projection screen for displaying the graphical interaction interface, may be approximately perpendicular to the second surface of the housing of the electronic device, to reduce fatigue of the user and to make it more comfortable for the user to use the electronic device. That is, the anterior part of the first hand on the first arm is laid in a same plane as the first arm. In this case, the projection lens may to be adjusted to project the graphical interaction interface onto the anterior part of the first hand. During adjusting the projection lens, the graphical interaction interface may be displayed on the anterior part of the first hand, and the graphical interaction interface may be displayed as a rectangle for a good display effect.

In the method for processing information according to the embodiment of the disclosure, the triggering information may be acquired through the sensor in the case that the electronic device is fixed to the first operation body of the user through the fixing structure.

The graphical interaction interface is projected through the projection lens onto the operation portion of the first operation body. In the method for processing information according to the disclosure, the graphical interaction interface may be projected onto the anterior part of the first hand of the user through the projection lens. Accordingly, the user may perform an information interaction with the electronic device through not only the graphical interaction interface displayed on the display of the electronic device, but also the graphical interaction interface displayed on the anterior part of the first hand, thereby achieving a better user experience.

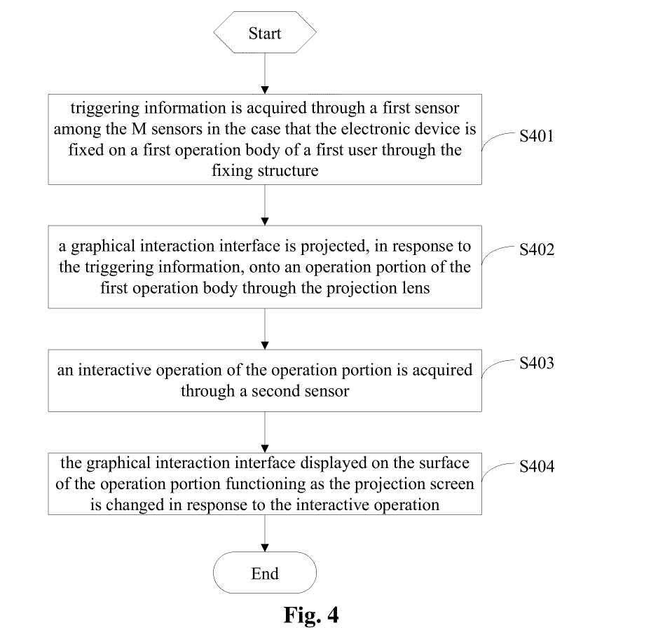

FIG. 4 is another schematic flowchart of a method for processing information according to an embodiment of the disclosure. The method may also be applied to the electronic device illustrated in FIG. 2. The method may include the following steps S401-S404.

In the step S401, triggering information is acquired through a first sensor among the M sensors in the case that the electronic device is fixed to a first operation body of a user through the fixing structure.

The first operation body is a first arm of the user and a first hand on the first arm.

According to the embodiment, there are many implementations for the electronic device to acquire the triggering information through the first sensor among the M sensors.

In one implementation, the first sensor may be a touch screen, and a touch button is displayed on the touch screen. The electronic device acquires the triggering information in the case that the touch screen detects that the touch button is touched.

In another implementation, the first sensor may be a physical button provided on the housing. The electronic device acquires the triggering information in the case that the physical button is pressed.

In still another implementation, the first sensor may be a camera. The camera may capture a gesture of the user. The electronic device may acquire the triggering information in the case that the gesture captured by the camera matches a set gesture.

In the step S402, a graphical interaction interface is projected, in response to the triggering information, onto an operation portion of the first operation body through the projection lens.

The operation portion and the second surface of the housing of the electronic device are located on a same side in the case that the electronic device is fixed to the first operation body of the user through the fixing structure.

The operation portion of the first operation body is the first hand on the first arm.

In one case, a surface of the operation portion of the first operation body, functioning as a projection screen for displaying the graphical interaction interface, may be approximately parallel to the second surface of the housing of the electronic device. That is, an anterior part of the first hand on the first arm is approximately perpendicular to the first arm. In this case, the electronic device may project the graphical interaction interface onto the anterior part of the first hand through the projection lens.

It should be understood that the user may feel tired if he keeps the anterior part of the first hand perpendicular to the first arm for a long time. In another case, the surface of the operation portion of the first operation body, functioning as the projection screen for displaying the graphical interaction interface, may be approximately perpendicular to the second surface of the housing of the electronic device, to reduce fatigue of the user and to make it more comfortable for the user to use the electronic device. That is, the anterior part of the first hand on the first arm is laid in a same plane as the first arm. In this case, the projection lens may to be adjusted to project the graphical interaction interface onto the anterior part of the first hand. During adjusting the projection lens, the graphical interaction interface is required to be displayed on the anterior part of the first hand, and the graphical interaction interface may be displayed as a rectangle for a good display effect.

In the step S403, an interactive operation of the operation portion is acquired through a second sensor.

The interactive operation is a gesture operation performed by the operation portion.

The second sensor may be provided on the fixing structure. For example, the second sensor may be provided as a pressure sensor array arranged at an inner side of the fixing structure. In the case that the operation body performs the interactive operation, a vibration of bones of the arm may be caused. The vibration of the bones acts on the pressure sensor array, and the electronic device may determine the interactive operation based on a pressure detected by the pressure sensor array.

Alternatively, the second sensor may be a camera which is fixed in the housing and exposed from the second surface.

In the step S404, the graphical interaction interface displayed on the surface of the operation portion functioning as the projection screen is changed in response to the interactive operation.

In one implementation, the interactive operation of the operation portion may be a flexion operation of one finger of the first hand.

Each finger of the first hand may correspond to one function or multiple functions.

In the case that each finger of the first hand corresponds to one function, an interface of a function corresponding to the flexion operation of the finger is displayed in response to the interactive operation.

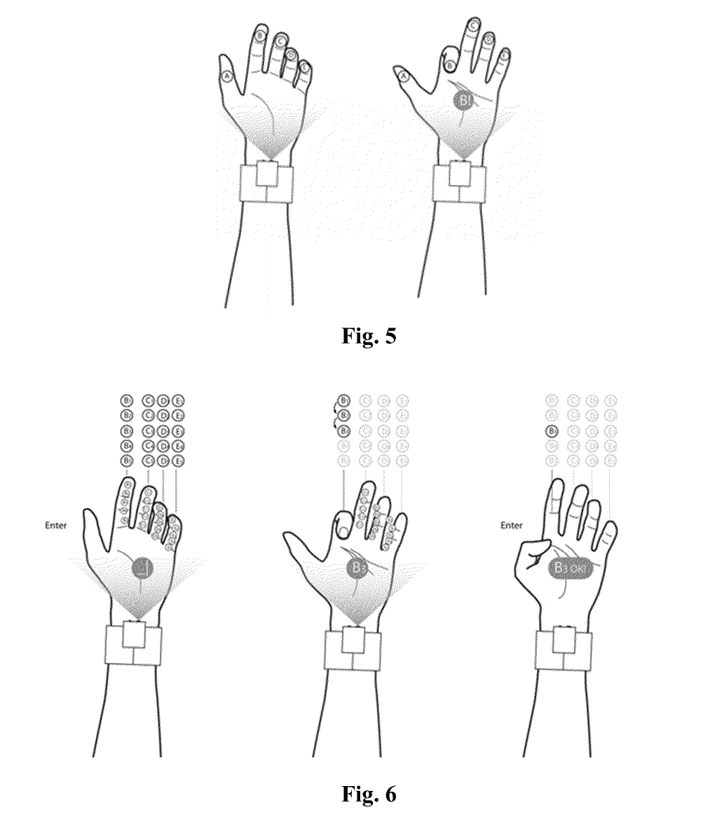

For example, as shown in FIG. 5, a thumb of the first hand corresponds to function A, a forefinger of the first hand corresponds to function B, a middle finger of the first hand corresponds to function C, a ring finger of the first hand corresponds to function D, and a little finger of the first hand corresponds to function E. In one situation, prompt information of the function corresponding to each finger may be displayed on the finger in the case that the electronic device controls the projection lens to project the graphical interaction interface onto the anterior part of the first hand. The user may easily know the functions corresponding to respective fingers through the prompt information. If the electronic device acquires, through the second sensor, the flexion operation of one finger, for example, the flexion operation of the forefinger, a currently displayed graphical interaction interface is switched into an interface of function B because the forefinger corresponds to function B. Cases of flexion operations of the other fingers are similar. In another situation, the prompt information of the functions is not displayed on the respective fingers in the case that the electronic device controls the projection lens to project the graphical interaction interface onto the anterior part of the first hand. If the electronic device acquires, through the second sensor, the flexion operation of one finger, for example, the flexion operation of the forefinger, a currently displayed graphical interaction interface is switched into an interface of function B. Cases of flexion operations of the other fingers are similar. In addition, it should be noted that the function corresponding to each finger may be set by the user.

In the case that each finger or a part of the fingers of the first hand correspond to multiple functions, switchings among the multiple functions may be achieved based on times of the flexion operation of the finger.

For example, as shown in FIG. 6, the thumb of the first hand corresponds to a selection function, the forefinger of the first hand corresponds to five functions of B1 to B5, the middle finger of the first hand corresponds to five functions of C1 to C5, the ring finger of the first hand corresponds to five functions of D1 to D5, and the little finger of the first hand corresponds to five functions of E1 to E5. Take the forefinger as an example, function B1 is switched to function B2 in the case that the electronic device acquires one flexing operation of the forefinger through the second sensor. Function B2 is switched to function B3 in the case that the electronic device acquires two continuous flexing operations of the forefinger through the second sensor. Here the user may select function B3 with the flexion operation of the thumb. An interface of function B3 may be displayed in the case that the electronic device acquires the flexion operation of the thumb through the second sensor.

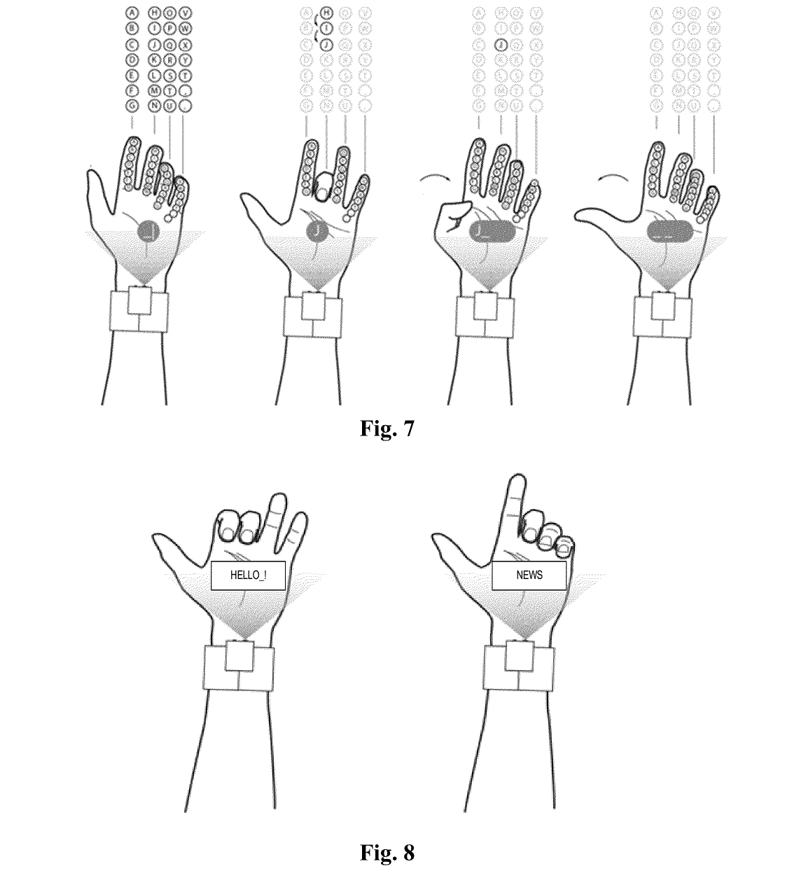

As shown in FIG. 7, each of the forefinger, the middle finger, the ring finger and the little finger of the first hand may correspond to multiple letters. Take the middle finger as an example, the middle finger corresponds to letters H, I, J, K, L, M, and N. Letter H is switched to letter I in the case that the middle finger is flexed once, and letter I is switched to letter J in the case that the middle finger is flexed twice. Here the user may move the thumb toward a palm of first hand from an initial position of the thumb to select letter J, and may move the thumb away from the palm of the first hand from the initial position of the thumb to trigger a return instruction.

There are other implementations in addition to the implementation described above.

In one implementation, the interactive operation of the operation portion may be an operation of moving the thumb of the first hand toward the palm from the initial position of the thumb. Here a determination instruction is triggered and an operation corresponding to the determination instruction is performed on an object displayed in the graphical interaction interface, in response to the interactive operation.

In another implementation, the interactive operation of the operation portion may be an operation of moving the thumb of the first hand away from the palm from the initial position of the thumb. Here a deletion instruction is triggered and an operation corresponding to the deletion instruction is performed on an object displayed in the graphical interaction interface, in response to the interactive operation.

In still another implementation, the interactive operation of the operation portion may be an operation of simultaneously flexing multiple fingers of the first hand. Different instructions are triggered by simultaneously flexing different combinations of fingers. Here an instruction corresponding to the operation of simultaneously flexing multiple fingers is triggered and an operation corresponding to the instruction is performed, in response to the interactive operation.

As shown in FIG. 8, an instruction of inserting a blank, for example, between two letters may be triggered by simultaneously flexing both the forefinger and the middle finger. A sharing instruction may be triggered by simultaneously flexing the middle finger, the ring finger and the little finger.

Furthermore, the operation of simultaneously flexing multiple fingers may be an operation of simultaneously flexing at least four fingers. Here triggering the instruction corresponding to the operation of simultaneously flexing the multiple fingers and performing the operation corresponding to the instruction include switching a graphical interaction interface currently displayed on the surface of the operation portion functioning as the projection screen into a main interface.

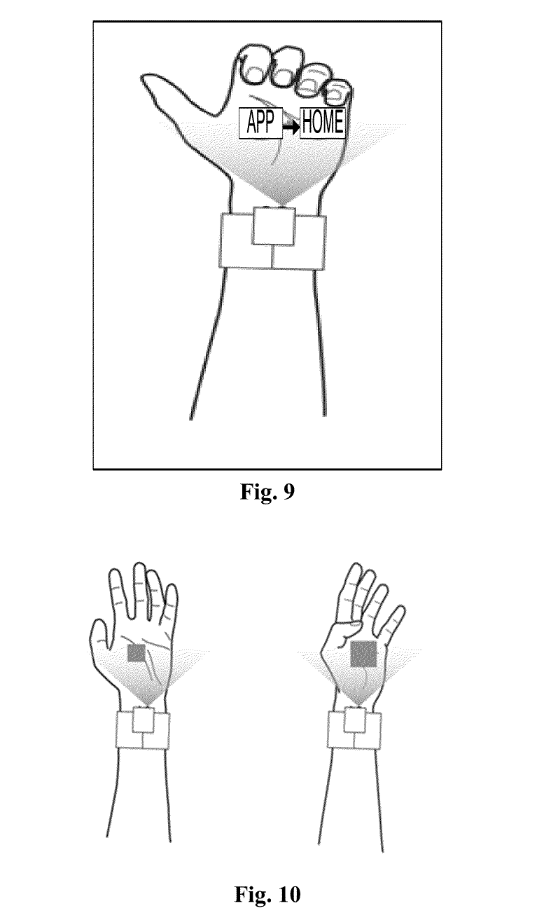

For example, as shown in FIG. 9, the electronic device switches the current graphical interaction interface into the main interface in the case that the forefinger, the middle finger, the ring finger and the little finger are simultaneously flexed.

In further another implementation, the interactive operation of the operation portion may be a rotation of the first hand, and a rotation of the first arm is caused due to the rotation of the first hand. Here an object displayed in the current graphical interactive interface is zoomed in response to the interactive operation. Whether the displayed object is zoomed in or zoomed out may be determined based on a direction of the rotation of the first arm.

According to the embodiment, the direction of the rotation of the first arm may be determined by an angle sensor and a gravity sensor.

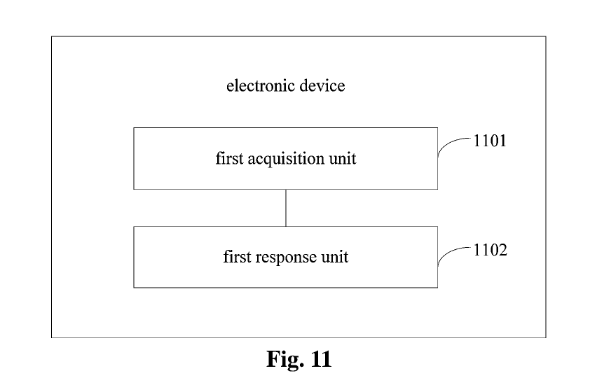

For example, as shown in FIG. 10, the displayed object is zoomed in if the first hand counterclockwise rotates, and the displayed object is zoomed out if the first hand clockwise rotates.

In the method for processing information according to the embodiment of the disclosure, the triggering information may be acquired by through the first sensor in the case that the electronic device is fixed to the first operation body of the user through the fixing structure. The graphical interaction interface is projected onto the operation portion of the first operation body through the projection lens. The graphical interaction interface displayed on the surface of the operation portion functioning as the projection screen may be changed in the case that the interactive operation of the operation portion is acquired by the second sensor. With the method for processing information according to the disclosure, the graphical interaction interface may be projected onto the anterior part of the first hand of the user through the projection lens. Accordingly, the user may perform an information interaction with the electronic device through not only the graphical interaction interface displayed on the display of the electronic device, but also the graphical interaction interface displayed on the anterior part of the first hand, and the user may operate on the graphical interaction interface with one hand, thereby achieving a better user experience.

In the methods for processing information according to the foregoing embodiments, the interactive operation is performed by the operation portion of the first operation body. For example, the electronic device is fixed to a left arm, the graphical interaction interface is projected onto the anterior part of a left hand, and the user performs operations on the graphical interaction interface through the left hand. Alternatively, the interactive operation may be performed by a second operation body. For example, the electronic device is fixed to the left arm, the graphical interaction interface is projected onto the anterior part of the left hand, and the user performs operations, with a right hand, on the graphical interaction interface displayed on the anterior part of the left hand. The interactive operation may be set gestures corresponding to various functions.

An electronic device corresponding to the forgoing methods is further provided according to an embodiment of the disclosure.

FIG. 11 is a schematic structural diagram of an electronic device according to an embodiment of the disclosure. The electronic device includes a housing, a first display component, a second display component and M sensors. The housing includes a fixing structure. The fixing structure may fix the electronic device on a first operation body of a user.

The first display component and the second display component are fixed on the housing. The first display component includes a display. The display is exposed on a first surface of the housing. The second display component includes a projection lens. The projection lens is exposed on a second surface of the housing. The first surface and the second surface intersect with each other. The M sensors are fixed through the housing. The electronic device further includes a first acquisition unit 1101 and a first response unit 1102.

The first acquisition unit 1101 is for acquiring triggering information through a first sensor among the M sensors in the case that the electronic device is fixed to the first operation body of the user through the fixing structure.

The first response unit 1102 is for projecting a graphical interaction interface onto an operation portion of the first operation body through the projection lens, in response to the triggering information.

The operation portion and the second surface of the housing of the electronic device are located on a same side in the case that the electronic device is fixed to the first operation body of the user through the fixing structure.

The operation portion of the first operation body is a first hand on the first arm.

In one implementation, a surface of the operation portion, functioning as a projection screen for displaying the graphical interaction interface, is approximately perpendicular to the second surface of the housing of the electronic device.

The triggering information may be acquired by the sensor in the case that the electronic device according to the embodiment of the disclosure is fixed to the first operation body of the user through the fixing structure. The graphical interaction interface is projected onto the operation portion of the first operation body through the projection lens. With the electronic device according to the embodiment of the disclosure, the graphical interaction interface may be projected onto the anterior part of the first hand of the user through the projection lens. Accordingly, the user may perform an information interaction with the electronic device through not only the graphical interaction interface displayed on the display of the electronic device, but also the graphical interaction interface displayed on the anterior part of the first hand, thereby achieving a better user experience.

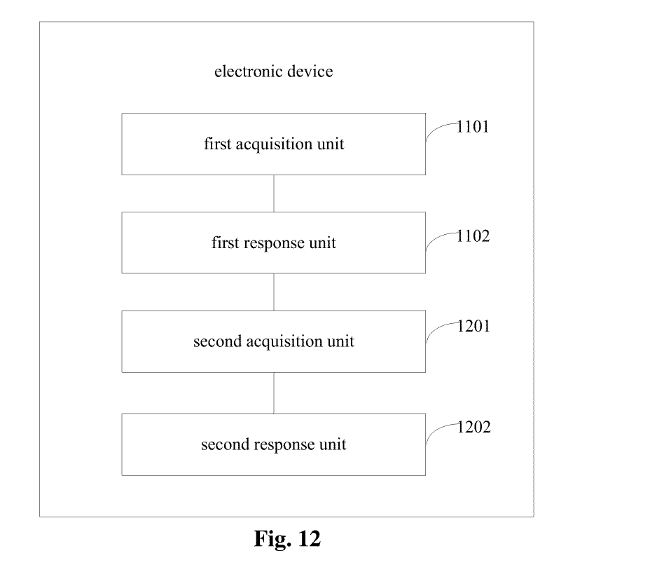

FIG. 12 is another schematic structural diagram of an electronic device according to an embodiment of the disclosure. Besides the first acquisition unit 1101 and the first response unit 1102 included in the electronic device according to the foregoing embodiment, the electronic device according to the embodiment further includes a second acquisition unit 1201 and a second response unit 1202.

The second acquisition unit 1201 is for acquiring an interactive operation of the operation portion through a second sensor.

According to the embodiment, the M sensors include the second sensor. The second sensor may be a pressure sensor array provided on the fixing structure, or a camera fixed in the housing and exposed from the second surface.

The second response unit 1202 is for changing the graphical interaction interface displayed on the surface of the operation portion functioning as the projection screen, in response to the interactive operation.

The operation body is a first arm of the user and a first hand on the first arm, and the operation portion is the first hand on the first arm.

In one implementation, the interactive operation of the operation portion is a flexing operation of one finger of the first hand. Each finger of the first hand corresponds to one function. Here the second response unit 1202 is for displaying an interface of the function corresponding to the flexing operation of the finger.

In one implementation, the interactive operation of the operation portion is an operation of moving a thumb of the first hand toward a palm of the first hand from an initial position of the thumb. Here the second response unit 1202 is for triggering a determination instruction and performing an operation corresponding to the determination instruction on an object displayed in the graphical interaction interface.

In one implementation, the interactive operation of the operation portion is an operation of moving the thumb of the first hand away from the palm of the first hand from the initial position of the thumb. Here the second response unit 1202 is for triggering a deletion instruction and performing an operation corresponding to the deletion instruction on an object displayed in the graphical interaction interface.

In one implementation, the interactive operation of the operation portion is an operation of simultaneously flexing multiple fingers of the first hand. Different instructions are triggered by simultaneously flexing different combinations of fingers. Here the second response unit is for triggering an instruction corresponding to the operation of simultaneously flexing multiple fingers and performing the operation corresponding to the instruction.

The operation of simultaneously flexing multiple fingers is an operation of simultaneously flexing at least four fingers. Here triggering the instruction corresponding to the operation of simultaneously flexing the multiple fingers and performing the operation corresponding to the instruction include switching a graphical interaction interface currently displayed on the surface of the operation portion functioning as the projection screen into a main interface.

In one implementation, the interactive operation of the operation portion is a rotation of the first hand, and a rotation of the first arm is caused due to the rotation of the first hand.

Here the second response unit 1202 is for zooming an object displayed in a current graphical interaction interface.

The triggering information may be acquired by the first sensor in the case that the electronic device according to the embodiment of the disclosure is fixed to the first operation body of the user through the fixing structure. The graphical interaction interface is projected onto the operation portion of the first operation body through the projection lens. The graphical interaction interface displayed on the surface of the operation portion functioning as the projective screen may be changed in the case that the interactive operation of the operation portion is acquired through the second sensor. With the electronic device according to the embodiment of the disclosure, the graphical interaction interface may be projected onto the anterior part of the first hand of the user through the projection lens. Accordingly, the user may perform an information interaction with the electronic device through not only the graphical interaction interface displayed on the display of the electronic device, but also the graphical interaction interface displayed on the anterior part of the first hand, and the user may perform operations on the graphical interaction interface with one hand, thereby achieving a better user experience.

It should be noted that, in the specification, the embodiments are described progressively. Differences from other embodiments are highlighted in the description of each embodiment, while similar parts among the embodiments may be referred to each other. Device embodiments or system embodiments, similar to method embodiments, are briefly described, and similar parts may be referred to descriptions of the method embodiments.

It should be further noted that, herein, relational terms such as “first” and “second” are only used to distinguish one entity or operation from another entity or operation, rather than to require or imply that there is such actual relationship or order between these entities or operations. Moreover, terms of “comprise”, “include” or any other variants thereof are non-exclusive. Accordingly, a process, method, article or device including a series of elements may include not only those elements, but also other elements which are not explicitly listed and inherent elements of the process, method, article or device. In case of no further restrictions, an element limited by a statement “includes a . . . ” does not exclude that there may be other similar elements in the process, method, article or device including the element.

Steps of the methods or the algorithms according to the embodiments of the disclosure may be implemented through any one or a combination of a hardware and a software module executed by a processor. The software module may be provided in a Random Access Memory (RAM), a memory, a Read-Only Memory (ROM), an electrically programmable ROM, an electrically erasable programmable ROM, a register, a hardware, a movable disc, a CD-ROM, or any other forms of conventional storage media.

With the above descriptions of the disclosed embodiments, those skilled in the art may implement or use the present disclosure. Various modifications to those embodiments are obvious to those skilled in the art, and ordinal principles defined in the present disclosure may be implemented in other embodiments without departing from the spirit or the scope of the present disclosure. Therefore, the present disclosure is not limited to those embodiments disclosed herein, but claims a widest scope in accordance with the principles and novel characteristics disclosed in the present disclosure.

1. A method comprising:
acquiring triggering information through a first sensor among a plurality of M sensors in the case that an electronic device is fixed to a first operation body of a user; and
projecting, using a projector and in response to the triggering information, a graphical interaction interface onto an operation portion of the first operation body through a projection lens.

2. The method according to claim 1, wherein the projecting onto an operation portion comprises projecting onto a surface of the operation portion, functioning as a projection screen for displaying the graphical interaction interface, is approximately perpendicular to a surface which supports the projector.

3. The method according to claim 2, wherein the M sensors comprise a second sensor, wherein the second sensor is a sensor selected from the group consisting of a pressure sensor array and a camera;
wherein the method further comprises:
acquiring an interactive operation of the operation portion through the second sensor; and
changing the graphical interaction interface displayed on the surface of the operation portion functioning as the projection screen, in response to the interactive operation.

4. The method according to claim 3, wherein the projection onto an operation portion of the first operation body is a projection onto a first arm of a user and a first hand on the first arm, and the operation portion is the first hand on the first arm; and
the acquiring interactive operation of the operation portion is an acquiring of an operation of simultaneously flexing a plurality of fingers of the first hand, different instructions are triggered by operations of simultaneously flexing different combinations of fingers of the first hand, and an instruction corresponding to the operation of simultaneously flexing the plurality of fingers is triggered and an operation corresponding to the instruction is performed, in response to the acquiring interactive operation.

5. The method according to claim 4, wherein the acquiring interactive operation of the operation portion is an acquiring of an operation of simultaneously flexing at least four fingers;
and the triggering the instruction corresponding to the acquiring of an operation of simultaneously flexing the plurality of fingers and performing the operation corresponding to the instruction comprises changing a graphical interaction interface currently displayed on the surface of the operation portion functioning as the projection screen into a main interface.

6. The method according to claim 3, wherein the projection onto an operation portion of the first operation body is a projection onto a first arm of a user and a first hand on the first arm, and the operation portion is the first hand on the first arm;
the acquiring interactive operation of the operation portion is an acquiring of a rotation of the first hand;
and an object displayed in a current graphical interaction interface is zoomed in responsive to the acquiring interactive operation.

7. An electronic device, comprising a housing which supports a first display component, a second display component and M sensors, wherein the housing comprises a fixing structure through which the electronic device is fixable to a first operation body of a user; wherein the first display component is exposed on a first surface of the housing; the second display component comprises a projection lens, wherein the projection lens is exposed on a second surface of the housing; and wherein the first surface and the second surface intersect with each other.

8. The electronic device according to claim 7, wherein the electronic device further comprises:
a first acquisition unit that acquires triggering information through a first sensor among the M sensors in the case that the electronic device is fixed to the first operation body of the user via the fixing structure; and
a first response unit that projects, in response to the triggering information, a graphical interaction interface onto an operation portion of the first operation body through the projection lens, wherein the operation portion and the second surface of the housing are located on a same side in the case that the electronic device is fixed to the first operation body of the user.

9. The electronic device according to claim 8, wherein the second surface of the housing is approximately perpendicular to a surface of the operation portion functioning as a projection screen for displaying the graphical interaction interface.

10. The electronic device according to claim 9, wherein the M sensors comprise a second sensor, the second sensor comprises a pressure sensor array provided on the fixing structure or a camera fixed in the housing and exposed from the second surface;
wherein the electronic device further comprises:
a second acquisition unit which acquires an interactive operation of the operation portion through the second sensor; and
a second response unit which changes, in response to the interactive operation, the graphical interaction interface displayed on the surface of the operation portion functioning as the projection screen.

11. The electronic device according to claim 10, wherein the projection onto an operation portion of the first operation body is a projection onto a first arm of the user and a first hand on the first arm, and the operation portion is the first hand on the first arm; and
the acquiring interactive operation of the operation portion is an acquiring of an operation of simultaneously flexing a plurality of fingers of the first hand, different instructions are triggered by operations of simultaneously flexing different combinations of fingers of the first hand, and the second response unit triggers an instruction corresponding to the operation of simultaneously flexing the plurality of fingers and performs an operation corresponding to the instruction.

12. The electronic device according to claim 11, wherein acquiring interactive operation of the operation portion is an acquiring of an operation of simultaneously flexing at least four fingers;
and the second response unit changes a graphical interaction interface currently displayed on the surface of the operation portion functioning as the projection screen into a main interface.

13. The electronic device according to claim 10, wherein the projection onto an operation portion of the first operation body is a projection onto a first arm of a user and a first hand on the first arm, and the operation portion is the first hand on the first arm;
the acquiring interactive operation of the operation portion is an acquiring of a rotation of the first hand;
and the second acquisition unit zooms an object displayed in a current graphical interaction interface.

14. A computer readable storage medium comprising computer executable instructions, the instructions comprising instructions to:
acquire triggering information through a first sensor among a plurality of M sensors in the case that the electronic device is fixed to the first operation body of a user; and
project, using a projector and in response to the triggering information, a graphical interaction interface onto an operation portion of the first operation body through a projection lens.

15. The method according to claim 3, wherein the projection onto an operation portion of the first operation body is a projection onto a first arm of a user and a first hand on the first arm, and the operation portion is the first hand on the first arm; and
the acquiring interactive operation of the operation portion is an acquiring of a flexion operation of one or more fingers of the first hand, wherein in the acquiring, each finger of the first hand corresponds to one function, and an interface of the function corresponding to the flexion operation of the finger is displayed in response to the acquiring interactive operation.

16. The method according to claim 3, wherein the projection onto an operation portion of the first operation body is a projection onto a first arm of a user and a first hand on the first arm, and the operation portion is the first hand on the first arm; and
the acquiring interactive operation of the operation portion is an acquiring of an operation of moving a thumb of the first hand toward a palm of the first hand from an initial position of the thumb, and a determination instruction is triggered and an operation corresponding to the determination instruction is performed on an object displayed in the graphical interaction interface, in response to the acquiring interactive operation.

17. The method according to claim 3, wherein the projection onto an operation portion of the first operation body is a projection onto a first arm of a user and a first hand on the first arm, and the operation portion is the first hand on the first arm; and
the acquiring interactive operation of the operation portion is an acquiring of an operation of moving a thumb of the first hand away from a palm of the first hand from an initial position of the thumb, and a deletion instruction is triggered and an operation corresponding to the deletion instruction is performed on an object displayed in the graphical interaction interface, in response to the acquiring interactive operation.

18. The electronic device according to claim 10, wherein the projection onto an operation portion of the first operation body is a projection onto a first arm of the user and a first hand on the first arm, and the operation portion is the first hand on the first arm; and
the acquiring interactive operation of the operation portion is an acquiring of a flexion operation of one or more fingers of the first hand, wherein in the acquiring, each finger of the first hand corresponds to one function, and the second response unit displays an interface of the function corresponding to the flexion operation of the finger.

19. The electronic device according to claim 10, wherein the projection onto an operation portion of the first operation body is a projection onto a first arm of the user and a first hand on the first arm, and the operation portion is the first hand on the first arm; and
the acquiring interactive operation of the operation portion is an acquiring of an operation of moving a thumb of the first hand toward a palm of the first hand from an initial position of the thumb, and the second response unit triggers a determination instruction and performs an operation corresponding to the determination instruction on an object displayed in the graphical interaction interface.

20. The electronic device according to claim 10, wherein the projection onto an operation portion of the first operation body is a projection onto a first arm of the user and a first hand on the first arm, and the operation portion is the first hand on the first arm; and
the acquiring interactive operation of the operation portion is an acquiring of an operation of moving a thumb of the first hand away from a palm of the first hand from an initial position of the thumb, and the second response unit triggers a deletion instruction and performs an operation corresponding to the deletion instruction on an object displayed in the graphical interaction interface.
